(19) United States
(12) Patent Application Publication
(10) Pub. No.: US 2019/0246656 A1
(43) Pub. Date: Aug. 15, 2019

(54) Dried Pumpkin Production Process

(71) Applicant: Min Luo, State College, PA (US)

(72) Inventor: Min Luo, State College, PA (US)

(21) Appl. No.: 15/893,335

(22) Filed: Feb. 9, 2018

(51) Int. Cl. A23B 7/02; A23L 19/00; A23L 5/00

(52) U.S. Cl. CPC A23B 7/0215; A23V 2002/00; A23L 5/55; A23L 19/03

(57) ABSTRACT

A method of production for dehydrated pumpkin slices is described. The method involves the dehydration of sliced pumpkin, followed by the rehydration of the slices. Seasoning and condiments are then applied for flavor. Then, the slices of pumpkin are dehydrated or dried naturally in a greenhouse a second time. The result of this process is a seasoned product tit for human consumption having a long shelf life. The method produces a healthy food product from materials often left unused in modern cuisine. The slices may be packaged similar to the way in which beef jerky is packaged and sold, as a snack product.

### FIELD OF THE PRESENT INVENTION

The present invention relates generally to methods of food dehydration, and more specifically relates to a method of conditioning pumpkins via a greenhouse-based drying process for human consumption.

### BACKGROUND OF THE PRESENT INVENTION

While there are many pumpkin-flavored foods present on the market today, few foods employ the raw fruit of the pumpkin, or similar gourds. It is often assumed that pumpkin skin and meat is not conducive to the human palate, however this need not be the case. It is known that pumpkin seeds can be a delicious and nutritious food when cooked properly. It is similarly true for the remainder of the pumpkin, however proper drying methods are not well known.

If there were an easy way that individuals could easily dry/dehydrate pumpkins, an additional food source made from the portion of the pumpkin often thrown away could be enjoyed, and less food would be wasted.

Thus, there is a need for a process that facilitates the drying and dehydration of pumpkins such that they may be packaged and sold as a portable snack. Such a process preferably leaves the pumpkin steamed and dried twice, such that they are dried to a specific degree that ensures good taste and freshness.

### SUMMARY OF THE PRESENT INVENTION

The present invention is a method for drying pumpkin slices for packaging and consumption. The method of the present invention enables a user to store pumpkins for long periods of time without spoiling. Additionally, the process of the present invention creates a delicious and healthy food from a product that is often thrown away, or not reserved for food aside from the pulp and/or seeds of the pumpkin.

### BRIEF DESCRIPTION OF THE DRAWINGS

The present invention will be better understood with reference to the appended drawing sheets, wherein:

FIG. 1 is a flow chart depicting the preferred process of use of the present invention.

### DETAILED DESCRIPTION OF THE PREFERRED EMBODIMENT

The present invention is a production process for drying pumpkins for human consumption. The process includes multiple rounds of steaming and drying, which produce a unique flavor conducive for snacking, similar to beef jerky. The end result of the process of the present invention is a pumpkin food product that may be packaged, has a long shelf life, and is delicious.

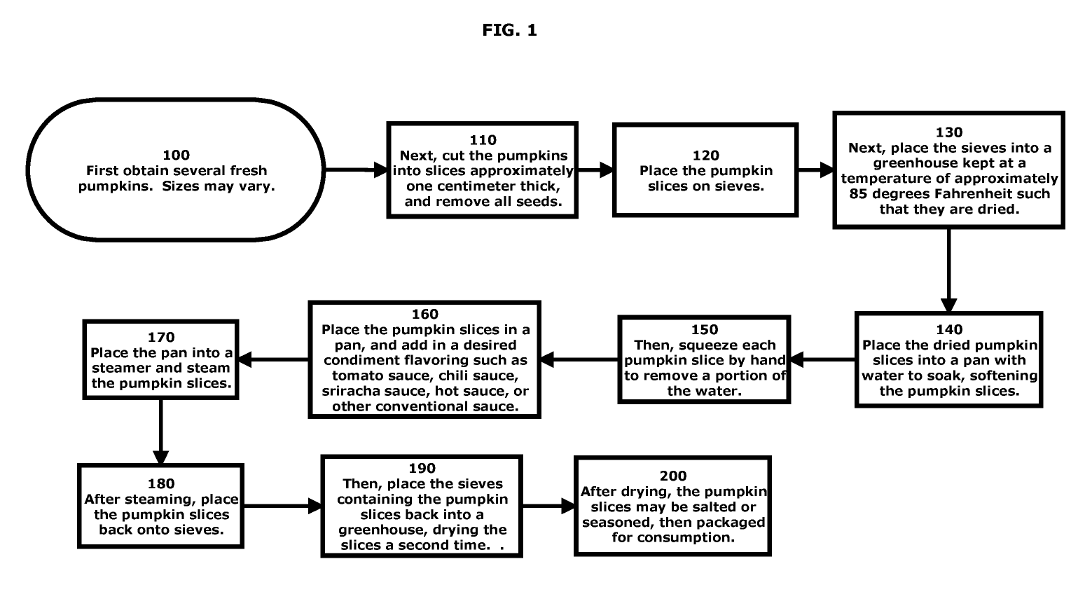

The process of use of the present invention, as depicted in FIG. 1, is preferably as follows:
1. First obtain several fresh pumpkins. Sizes may vary. (100)
2. Next, cut the pumpkins into slices approximately one centimeter thick, and remove all seeds. (110)
3. Place the pumpkin slices on sieves. (120)
4. Next, place the sieves into a greenhouse kept at a temperature of approximately 85 degrees Fahrenheit such that they are dried. (130) It is envisioned that the slices should be left to dry on the sieves until they are completely dry, as they will be moldy if they are not left until completely dry.
5. Place the dried pumpkin slices into a pan with water to soak, softening the pumpkin slices. (140) The slices are preferably soaked for about three hours, or until adequately soft.
6. Then, squeeze each pumpkin slice by hand to remove a portion of the water. (150)
7. Place the pumpkin slices in a pot or pan, and add in a desired condiment flavoring such as tomato sauce, chili sauce, sriracha sauce, hot sauce, or other conventional sauce. (160) The amount of condiment(s) added may vary depending on consumers' preferences. When mixing in the condiment(s), the slices are preferably still wet. The user may desire to add some glutinous rice flour, corn flour, raw powder, or similar such that the pumpkin slices are not too wet. Prior to mixing in the condiments), the user may additionally add in a form of food oil, such as vegetable oil, peanut oil, olive oil, or similar.
8. Place the pan into a steamer and steam the pumpkin slices. (170) A conventional steamer preferably used. The slices are preferably steamed for approximately 30 minutes, cooking the pumpkin slices, and locking in the flavor of the condiment(s).
9. After steaming, place the pumpkin slices back onto sieves. (180)
10. Then, place the sieves containing the pumpkin slices back into a greenhouse, drying the slices a second time. (190) The slices are preferably dried to the taste of the user.
11. After drying, the pumpkin slices may be salted or seasoned, then packaged for consumption. (200)

Alternate embodiments of the present invention include variations on the thickness of the pumpkin slices, as well as variations on the duration of time used for drying and for condiment absorption. The end result of the system and process of the present invention may be achieved without the use of a greenhouse, however more time to complete the process is required. If the sun is out, the pumpkin slices may be placed into the sun in order to dry the pumpkin slices. However, if the sun is not out, this alternative is not advised, as pumpkin slices may mold easily if not dried relatively quickly. Additionally, flies may be present, which are not ideal. Similarly, the pumpkin slices may be placed into an oven to dry, however the heating surface is not uniform, and is therefore less ideal than use of a greenhouse to dry the slices. A heater fan within a small room may also alternatively be used to dry the slices.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method for drying pumpkins for consumption comprising:
cutting the pumpkin into slices;
removing all pumpkin seeds from the slices;
arranging the slices on sieves;
placing the sieves containing the slices into a greenhouse for 24 hours with a temperature of 85 degrees, drying the slices;
rehydrating the slices in a pan of water, softening the slices;
removing the slices from the pan of water;
drying the slices by hand;
placing the slices into a pan;
adding at least one condiment to the pan;
placing the pan into a steamer, steaming the slices for 30 minutes;
removing the slices from the steamer and pan;
placing the slices on sieves a second time;
placing the sieves containing the slices into a greenhouse for a second time, drying the slices;
removing the slices from the greenhouse after 12 hours have elapsed;
seasoning the slices with at least one condiment; and
packaging the slices for consumption.
